(19) United States
(12) Patent Application Publication
(10) Pub. No.: US 2013/0096769 A1
(43) Pub. Date: Apr. 18, 2013

(54) ELECTRONIC CONTROL UNIT

(71) Applicant: DENSO CORPORATION, Kariya-city (JP)

(72) Inventors: Yoshikuni KAWAMURA, Obu-city (JP); Hiroyuki ENOMOTO, Kariya-city (JP); Kazunori OKADA, Chiryu-city (JP)

(73) Assignee: DENSO CORPORATION, Kariya-city (JP)

(21) Appl. No.: 13/650,304

(22) Filed: Oct. 12, 2012

(30) Foreign Application Priority Data
Oct. 13, 2011 (JP) 2011-225698

(51) Int. Cl. G06F 17/00

(52) U.S. Cl. 701/31.4

(57) ABSTRACT

An electronic control unit (ECU) includes an abnormality detection unit, a storage unit, and a communication unit. The abnormality detection unit detects a vehicle abnormality, and the storage unit stores, at the time the vehicle abnormality is detected by the abnormality detection unit, predetermined driving information of the vehicle in a memory unit. In addition, the communication unit transmits the driving information stored in the memory unit to a remote center, where the driving information is stored along with vehicle identification information for identifying the vehicle. The communication unit may interrupt a communication process that is being performed in order to transmit the driving information to the remote center after the storage control unit stores the driving information in the memory unit.

### CROSS REFERENCE TO RELATED APPLICATION

The present application is based on and claims the benefit of priority of Japanese Patent Application No. 2011-225698, filed on Oct. 13, 2011, the disclosure of which is incorporated herein by reference.

### TECHNICAL FIELD

The present disclosure generally relates to an electronic control unit that stores driving information in a vehicle abnormal time to determine a cause of a vehicle abnormality.

### BACKGROUND

Conventionally, as disclosed in U.S. Pat. No. 5754965 (US '965), a technique to diagnose a vehicle behavior based on detection signals from various sensors in a subject vehicle and to analyze a cause of the vehicle behavior is known. Further, a technique to store, as driving information, output information from various sensors before and after a collision, which has caused an impact on a subject vehicle, is also known.

Further, in another conventional technique, diagnosis codes corresponding to a sensor/actuator abnormality as well as time-lapse sensor outputs and control data over a certain period due to such abnormality, are stored as driving information (i.e., freeze frame data).

In another conventional technique, even when sensors and actuators are normal, an unexpected vehicle behavior is detected by comparing the vehicle behavior with a determination criteria. The unexpected vehicle behavior may be generated in a manner that does not correspond to an operation of a vehicular device by the vehicle driver. Once such unexpected vehicle behavior is detected, driving information at the time of detecting the unexpected behavior is stored.

If a vehicle abnormality, such as a collision, a sensor abnormality, or non-corresponding vehicle behavior, occurs, the driving information, such as sensor signals, control signals, at such time is stored in a data storage unit. The data storage unit retains the driving information even at a vehicle operation stop time. The driving information may be retrieved at a dealership via a diagnosis tool, where the cause of vehicle abnormality may be analyzed. After the retrieval of the driving information from the data storage unit at the dealership, the driving information may be erased from the data storage unit by sending an erase request from the diagnosis tool to the data storage unit.

Upon receiving a request for disclosing the information, the driving information stored in the data storage unit may be made available to a user through a vehicular device, such as a navigation apparatus. Once the driving information stored in the subject vehicle is made available through an operation of the vehicular device at, for example, a dealership, for analysis of the vehicle abnormality, the driving information may be erased. In particular the driving information may be erased in an erase mode, which may be realized through an operation of the vehicular device, after the driving information is retrieved from the data storage unit.

If such erase mode for erasing the driving information is provided via the vehicular device, a password may be used to prevent the user from accidentally placing the vehicular device in the erase mode. However, the user may accidentally erase the driving information from the data storage unit before the driving information is retrieved at the dealership when a randomly input password matches with the real password.

### SUMMARY

It is an object of the present disclosure to provide an electronic control unit that enables analysis of the cause of vehicle abnormality even when the driving information that is stored at a time of generation of vehicle abnormality is accidentally erased.

In an aspect of the present disclosure an electronic control unit (ECU) in a vehicle includes: an abnormality detection unit that detects a vehicle abnormality, and a storage control unit that stores, at a time of detection of the vehicle abnormality by the abnormality detection unit, predetermined driving information of the vehicle in a memory unit In addition the ECU includes a communication unit that transmits the driving information to a remote center, where the remote center stores the driving information, which is stored in the memory unit.

The communication unit may also transmit the driving information to the remote center when the storage control unit stores the driving information in the memory unit. In such configuration, when the vehicle abnormality is detected, the driving information is stored in the memory unit of the vehicle, and, at the same time, the driving information is transmitted to the remote center, to be stored therein. Therefore, even if the driving information stored in the memory unit is erased by mistake, the cause of the vehicle abnormality can still be analyzed, based on the driving information stored in the remote center.

When the abnormality detection unit detects the vehicle abnormality, the communication unit may interrupt a currently performing communication process, and may transmit the driving information to the remote center after the driving information is stored in the memory unit by the storage control unit. In such manner, when a vehicle abnormality is observed, the driving information at a time of generation of vehicle abnormality is transmitted to the remote center without being interrupted by the communication process that is currently being performed.

Further, the ECU may include a reception unit and an erasure unit. The reception unit may receive an erasure request for erasing the driving information stored in the memory unit. When the reception unit receives the erasure request for erasing the driving information, the communication unit transmits the driving information, which has been stored in the memory unit, to the remote center. In addition, the erasure unit erases the driving information stored in the memory unit after the reception unit receives the erasure request and (ii) the communication unit transmits the driving information to the remote center.

In such manner, the driving information stored in the memory unit is transmitted to the remote center before the erasure unit erases the driving information from the memory unit. Therefore, even after the erasure of the driving information from the memory unit, the cause of the vehicle abnormality may be analyzed based on the driving information stored in the remote center.

When the reception unit receives the erasure request, the communication unit may transmit an erasure permission inquiry to the remote center. The erasure permission inquiry requests permission to erase the driving information stored in the memory unit. The erasure unit may erase the driving information stored in the memory unit when the communication unit receives an erasure permission from the remote center.

In such manner, if the remote center does not permit the erasure, the driving information stored in the memory unit of the vehicle, which is the same as the one stored in the remote center, is maintained. Therefore, even when one of the remote center and the vehicle mistakenly erases the driving information, the other side has the driving information.

The reception unit may not be able to receive the erasure request while the communication unit is transmitting the driving information to the remote center. In such manner, without being interrupted by the erasure process performed by the erasure unit, the communication unit can transmit the driving information stored in the memory unit to the remote center.

The ECU may also include a notification unit that notifies, via a notification device, completion of an erasure process for erasing the driving information. In such manner, even when the erasure process of the driving information is prolonged, the user who has requested the erasure of the driving information can get a sense of security at a time of seeing the message of erasure completion.

Further, each of the functions respectively corresponding to the each of the above-described units may be realized/implemented either as a hardware component identified by the name/configuration of the respective units, as a program component identified by the name/configuration of the respective programs, or as a combination/association between the hardware components and the program components. Further, each of the functions respectively corresponding to each of the above-described units may not necessarily be limited to the base functions that are realized by physically-independent hardware components.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of a driving information processing system of the present disclosure;

FIG. 2 is a flowchart of a first driving information handling process in the first embodiment;

FIG. 3 is a flowchart of a second driving information handling process in a second embodiment;

FIG. 4 is a flowchart of a third driving information handling process in a third embodiment; and

FIG. 5 is a flowchart a fourth driving information handling process of the third embodiment.

### DETAILED DESCRIPTION

Embodiments of the present disclosure are described with reference to the drawings in the following.

### First Embodiment

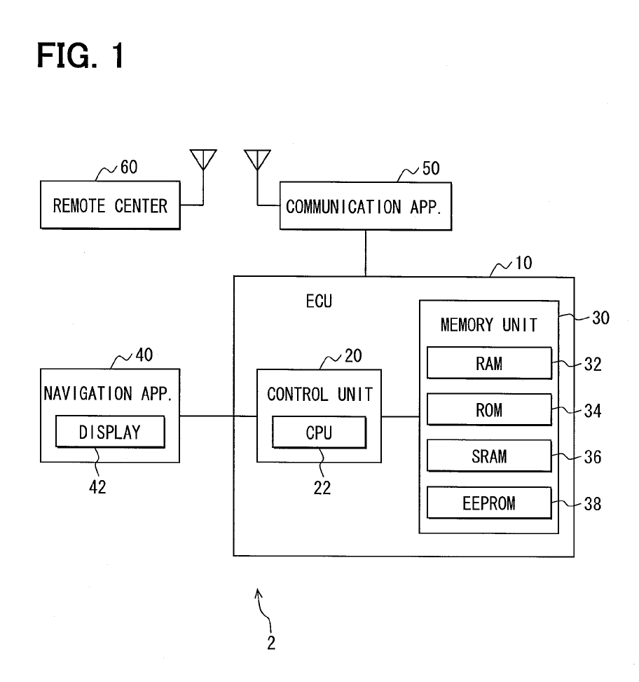

With reference to FIG. 1, a driving information processing system 2, disposed in a vehicle, handles driving information at a vehicle abnormal time. The driving information processing system 2 includes an electronic control unit (ECU) 10, a navigation apparatus 40, a wireless communication device 50, and a remote center 60.

The ECU 10 may be, for example, an engine ECU for performing an injection control of an injector and an ignition control of an ignition plug. The ECU 10 may be implemented as a microcomputer having a control unit 20, a memory unit 30, and an input and output circuit, which is not illustrated.

Based on detection signals from various sensors, the ECU 10 may execute a control program to control the engine for providing, for example, the injection control of the injector and the ignition control of the spark plug. The control program may be stored in a ROM 34 of the memory unit 30, and the control program is executed by a CPU 22 of the control unit 20. The detection signals from various sensors represent driving conditions of the vehicle, such as an accelerator opening, a throttle opening, a crank angle, and water temperature.

The memory unit 30 includes a RAM 32, ROM 34, a SRAM (i.e., Standby RAM) 36, and an EEPROM 38. The RAM 32 is used as a work area of the control program executed in the ECU 10, and loses the data stored therein when power supply to RAM 32 is interrupted. Unlike the RAM 31, SRAM 36 receives a continuous supply of power, such that even when the ignition switch is turned off SRAM 36 receives power from a battery, whereas RAM 32 does not. Therefore, the data stored in SRAM 36 is retained as long the power supply is not interrupted.

EEPROM 38 is a nonvolatile memory unit, contents of which can be re-written. The data stored in EEPROM 38 is retained even when the power supply from a battery is interrupted.

The navigation apparatus 40 displays via the display 42, a position of the subject vehicle on the map based on map data and a position of the subject vehicle measured by a Global Positioning System (GPS) transmitting signals to a GPS receiver (not illustrated) on the subject vehicle, and guides a travel route toward a destination.

Further, the navigation apparatus 40 has a function that displays, on the display 42 according to a user operation, the driving information, which is stored in EEPROM 38 at the vehicle abnormal time.

The wireless communication device 50 performs wireless communication between the ECU 10 and the remote center 60.

The functions realized by the CPU 10 under control of the execution of the control program stored in ROM 34 by CPU 22 are described in the following.

(Abnormality Detection Unit)

The ECU 10 detects whether vehicle abnormality in the following items (1) to (3) is generated based on the detection signal from various sensors.

(1) Though a vehicle driver does not step on an accelerator pedal, an engine rotation number unintentionally rises above a predetermined value or a throttle opening exceeds a predetermined opening, which is considered as an abnormal vehicle behavior that does not correspond to the control of the vehicle driver.

(2) A collision of a vehicle detected by acceleration sensors or the like.

(3) Abnormality of the sensor/actuator. If it is a sensor, the abnormality is detected as a condition of continuous/fixed “high” or “low” detection signal. If it is an actuator, the abnormality is detected as a condition of not performing an operation according to a control signal.

Further, the ECU 10 may detect the generation of abnormality of the vehicle behavior, based on a switch operation performed by an occupant of the vehicle.

(Storage Control Unit)

When the ECU 10 detects the vehicle abnormality, it stores the driving information of pre-selected kinds in EEPROM 38. Stored driving information may be detection signals, such as an accelerator opening, a throttle opening, a shifting position of transmission gear, water temperature, an air-intake amount, intake air temperature, a vehicle speed, an engine rotation number detection signals, which are acquired from various sensors, as well as an injection amount instruction for the injector, an ignition timing for the spark plug and the like.

Further, the storage area of EEPROM 38 in which the driving information at the time of vehicle abnormality may be overwritten time to time at each occasion of the vehicle abnormality, or may be configured to be a “ring-buffer” which is capable of storing the driving information at the time of abnormality for a certain number of abnormality occasions, with the overwriting of the oldest data by the newest. Driving information stored at the time of abnormality may simply be referred to as abnormality time driving information.

Since the driving information is stored in EEPROM 38, when an ignition switch is turned off, the abnormality time driving information stored in the EEPROM 38 is maintained. Therefore, by bringing the vehicle having the abnormality to the dealership, the driving information stored is retrieved from EEPROM 38 by using, for example, a diagnosis tool, and the cause of the abnormality is analyzed.

(Communication Unit)

When the ECU 10 detects vehicle abnormality, and stores the driving information of the vehicle of pre-selected kinds in EEPROM 38, it transmits the driving information, as stored (i.e., the same driving information), to the remote center 60 by the wireless communication device 50. At such time, the ECU 10 also transmits identification information, such as a vehicle identification number (VIN), identifying the vehicle to the remote center 60 with the driving information.

When the VIN and driving information are transmitted from the vehicle, the remote center 60 stores the transmitted driving information, for each of the vehicles (i.e., vehicle to vehicle). In such manner, the driving information is stored in both the vehicle and the remote center 60. The configuration of the storage area storing the driving information in the remote center 60 is set to have the same configuration as EEPROM 38 of the vehicle based on the VIN transmitted from the vehicle.

(First Driving Information Handling Process)

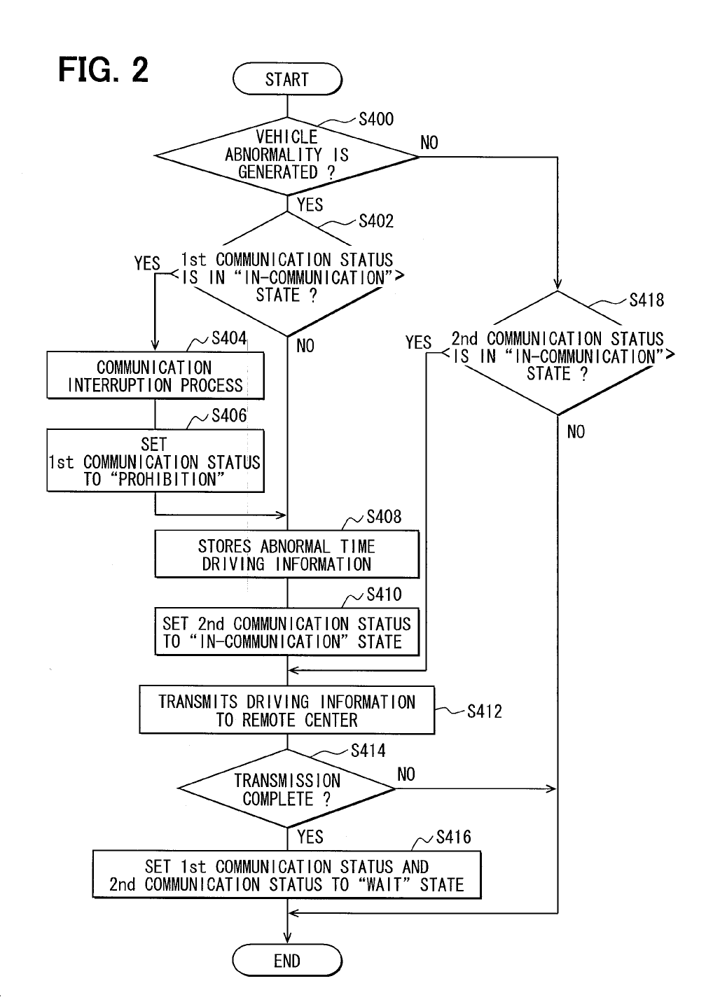

A driving information handling process of the first embodiment (i.e., a first driving information handling process) is described with reference to FIG. 2. The first driving handling process is continuously performed by the ECU 10. “S” in flowcharts in FIG. 2 and others represents a “Step.”

The ECU 10, in S400, determines whether a vehicle abnormality is detected. When a vehicle abnormality is detected (S400: Yes), the process moves to S402, and, when a vehicle abnormality has not been detected (S400: No), the process moves to S418.

In S402, when a first communication status is in an in-communication state (S402: Yes), the process continues to S408 after performing S404 and S406, and, when the first communication status is not in the in-communication state (S402: No), the process moves to S408 without performing S404 and S406.

The first communication status is a general purpose communication information representing whether or not the ECU 10 is communicating with the remote center 60 or with other in-vehicle devices for exchanging data other than the abnormal time driving information. The first communication status represents one of three states, that is, an “in-communication” state, a “wait” state, or a “prohibition” state.

The “in-communication” state indicates that the ECU 10 is exchanging data with the remote center 60 or other in-vehicle devices, where the data being exchanged is not the abnormal time driving information. The “wait” state indicates that communication by a process other than the process in FIG. 2 is allowed. The “prohibition” indicates that communication by a process other than the process in FIG. 2 is prohibited.

When the first communication status is provided as “in-communication” state (S402: Yes), the process, in S404, interrupts the communication between the ECU 10 and either the remote center 60 or other in-vehicle devices, and in S406, the first communication status is set to “prohibition” in order to prohibit communication by a process other than the process of FIG. 2 from occurring. In S408, the process stores the abnormal time driving information in EEPROM 38, and, in S410, sets a second communication status to the “in-communication” state. The process then, in S412, transmits the driving information from EEPROM 38 to the remote center 60. When such transmission is completed (S414: Yes), the process, in S416, sets the first communication status and the second communication status to the “wait” state, and concludes the present process.

The second communication status is dedicated communication information representing whether or not the ECU 10 is communicating with the remote center 60 for transmission of the abnormal time driving information. The second communication status represents one of two states, that is, an “in-communication” state or a “wait” state. In S418, the ECU 10 determines whether the second communication status is in the “in-communication” state. When the second communication status is in the “in-communication” state (S418: Yes), the ECU 10 determines that it is transmitting the driving information to the remote center 60, and performs S412 to S416.

In the first embodiment, at the time of a vehicle abnormality, if the ECU 10 is in communication with the remote center 60 or other in-vehicle devices transmitting data other than the abnormal time driving information the ECU 10 stops data communication with the remote center 60 or other in-vehicle devices and transmits the abnormal time driving information to the remote center 60.

In such manner, the ECU 10 can transmit the abnormal time driving information to the remote center 60 and the abnormal time driving information transmitted can be stored in the remote center 60, without interruption from other communication processes.

In the first embodiment, EEPROM 38 may correspond to a memory unit in claims. Further, the ECU 10 may be provided as an abnormality detection unit, a storage control unit, and a communication unit in claims.

Further, in the first driving information handling process of FIG. 2, a process of S400 corresponds to the function performed by an abnormality detection unit, and a process of S402 to S406 and a process of S410 to S418 corresponds to the function performed by a communication unit, and a process of S408 corresponds to the function performed by a memory unit.

### Second Embodiment

The driving information processing system of the second embodiment basically has the same configuration as the driving information processing system 2 of the first embodiment. However, in the second embodiment, by inputting a password to the navigation apparatus 40, the navigation apparatus 40 can request the ECU 10 to erase the driving information that is stored in EEPROM 38.

Further, in the second embodiment, instead of transmitting the driving information stored in EEPROM 38 to the remote center 60 at the time of vehicle abnormality, the driving information stored in EEPROM 38 is transmitted to the remote center 60 when the navigation apparatus 40 requests the erasure of the driving information stored in EEPROM 38.

The ECU 10 of the second embodiment may function as a reception unit, an erase unit, and a notification unit as well as an abnormality detection unit, a storage control unit, and a communication unit described in the first embodiment. However, the function of the communication unit in the second embodiment is different from the function of the communication unit in the first embodiment.

(Reception Unit)

Upon receiving a user request through an operation of the navigation apparatus 40, the ECU 10 accepts an erasure request of the driving information stored in EEPROM 38, unless it is transmitting the driving information to the remote center 60.

(Erase Unit)

Upon accepting the erasure request for erasing the driving information in EEPROM 38, the ECU 10 erases the driving information stored in EEPROM 38.

(Notification Unit)

The ECU 10 controls the navigation apparatus 40 to have the display 42 display “Erasure complete” after accepting the erasure request of the driving information stored in EEPROM 38 until the completion of the transmission of the driving information to the remote center 60 and the completion of the erasure of the driving information in EEPROM 38. In such manner, the user is informed that a erasure process has smoothly completed based on the erasure request of the driving information. The message of “Erasure complete” may be displayed on the display 42 for a predetermined time after accepting the erasure request of the driving information.

(Communication Unit)

The ECU 10 transmits the driving information stored in EEPROM 38 to the remote center 60 by using the wireless communication device 50, when the erasure of the driving information in the EEPROM 38 is requested by the navigation apparatus 40. When transmitting the driving information to the remote center 60, the ECU 10 also transmits identification information, such as the VIN, for identifying the vehicle to the remote center 60 together with the driving information. The remote center 60 stores the driving information provided by a vehicle, when it receives the VIN and the driving information.

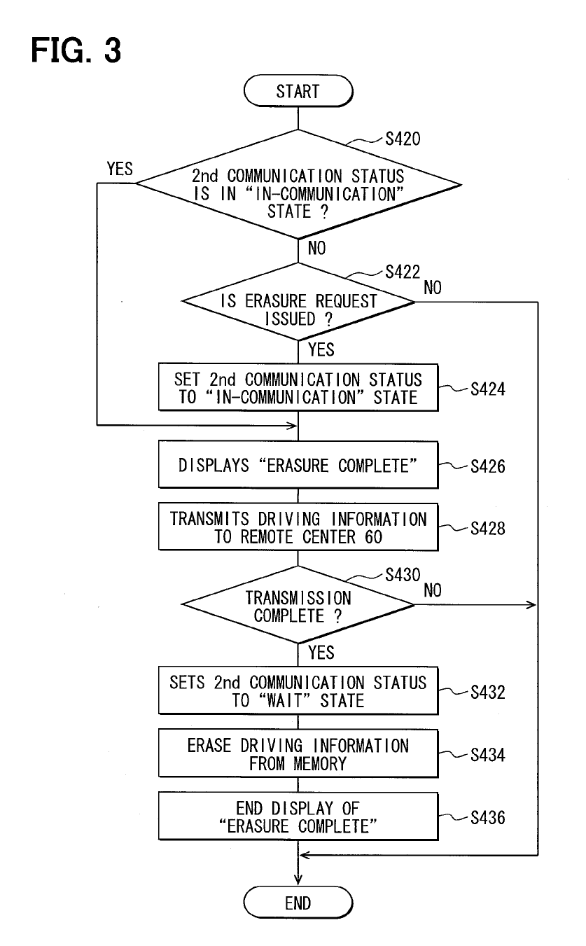

In the following, a driving information handling process of the second embodiment (i.e., a second driving information handling process hereinafter) is described with reference to FIG. 3. The second driving information handling process is performed when a erasure request is generated for erasing the abnormal time driving information stored in EEPROM 38. The second driving information handling process is continuously performed by the ECU 10.

(Second Driving Information Handling Process)

The process, in S420, determines whether the second communication status is in the “in-communication” state. The second communication status is dedicated communication information, as described in the first embodiment, representing whether the ECU 10 is communicating with the remote center 60 for transmission of the abnormal time driving information.

If the second communication status is not in the “in-communication” state (S420: No), the process, in S422, determines whether the navigation apparatus 40 has issued an erasure request of the driving information stored in EEPROM 38, and if the second communication status is in the “in-communication” state (S420: Yes), the process continues to S426.

If the second communication status is in the “in-communication” state (S420: Yes), the process continues to S426, and does not perform the determination of S422. Therefore, while the second communication status is in the “in-communication” state, the erasure request of the driving information from the navigation apparatus 40 will be ignored.

When the second communication status is not in the “in-communication” state (S420: No) and if the erasure request of the driving information is accepted (S422: Yes), the process, in S424, sets the second communication status to the “in-communication” stat, and shifts to S426. When the second communication status is not in the “in-communication” state (S420: No), and if the erasure request of the driving information does not exist (S422: No), the process concludes.

In S426, the ECU 10 controls the navigation apparatus 40 to have the display 42 display “Erasure complete,” and in S428 transmits the driving information stored in EEPROM 38 to the remote center 60 from the wireless communication device 50.

When the transmission of the driving information is complete (S430: Yes), the process, in S432, sets the second communication status to the “wait” state, and, in S434, erases the driving information stored in EEPROM 38. The process, in S436, then controls the navigation apparatus 40 to end the display of “Erasure complete” on the display 42.

In the second embodiment described above, upon having an erasure request for erasing the driving information that is stored in EEPROM 38, the driving information is transmitted to the remote center 60 before the erasure from EEPROM 38. The remote center 60 stores the driving information transmitted from a vehicle based on the identification information, such as the VIN.

In such manner, even when the abnormal time driving information is erased from the vehicle, the erased information is stored in the remote center 60, thereby allowing the analysis of the cause of vehicle abnormality based on the driving information in the remote center 60.

Further, during the transmission of the driving information to the remote center 60 by the ECU 10, the erasure process for erasing the driving information is ignored. Therefore, the ECU 10 can securely transmit the driving information to the remote center 60.

Further, upon accepting the erasure request of the driving information, “Erasure complete” message is displayed on the display 42, and, upon completing the erasure process for transmitting the driving information to the remote center 60 and for erasing the driving information from EEPROM 38, display of “Erasure complete” message ends. In such manner, even when the erasure process of the driving information is prolonged, the user who has requested the erasure of the driving information from the navigation apparatus 40 can get a sense of security at a time of seeing the message of completion.

In the second embodiment, the display 42 may correspond to a notification unit in claims. Further, in the second driving information handling process of FIG. 3, a process shifting from S420 to S426 on condition that the second communication status in S420 is in the “in-communication” state and a process of S422 may correspond to a reception unit, and a process in S426 and in S436 may correspond a notification unit, and a process in S428 may correspond to a communication unit, and a process in S434 may correspond to an erase unit.

### Third Embodiment

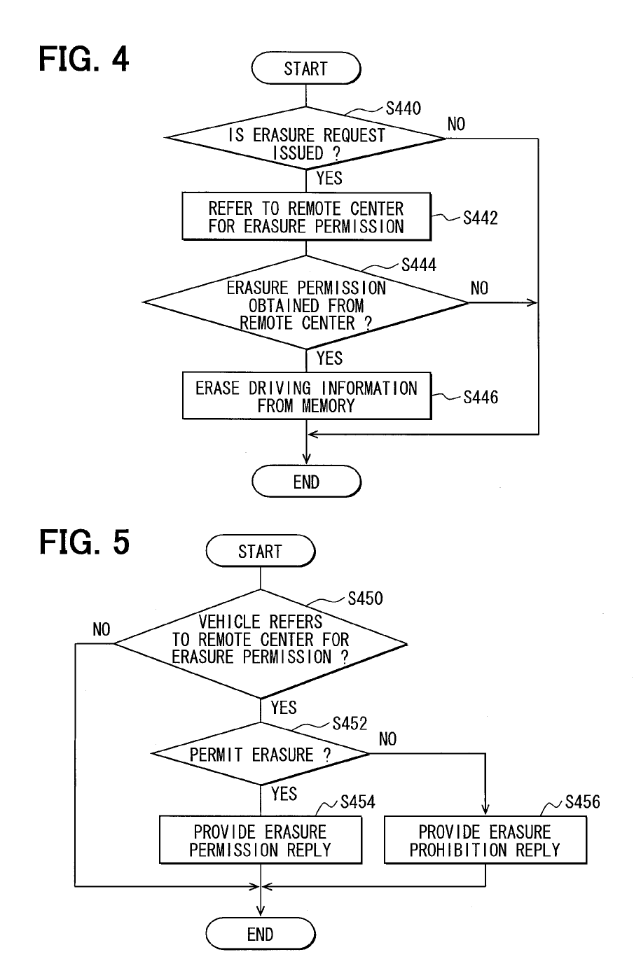

The driving information processing system of the third embodiment basically has the same configuration as the driving information processing system of the second embodiment. A description of a third and a fourth driving information handling process of the third embodiment is described with reference to FIGS. 4 and 5, respectively. The third driving information handling process is performed by the ECU 10 disposed in the vehicle and the fourth driving information handling process is performed by the remote center 60.

(Third Driving Information Handling Process)

The third driving information handling process of FIG. 4 is performed when the navigation apparatus 40 requests the erasure of the driving information stored in EEPROM 38 after (i) the storage of the abnormal time driving information in EEPROM 38 of the ECU 10 and (ii) the transmission of the abnormal time driving information that has been stored in EEPROM 38 to the remote center 60.

Therefore, it will be performed (i) after, for example, the first driving information handling process of FIG. 2 is concluded, or, (ii) after performing S432 of FIG. 3 and before erasing the driving information in S434.

The ECU 10 determines, in S440 of FIG. 4, whether the navigation apparatus 40 issued the erasure request of the driving information stored in EEPROM 38. When the erasure request is not issued (S440: No), the ECU 10 concludes the present process.

When the erasure request of the driving information is issued (S440: Yes), the ECU 10 refers to the remote center 60 for an erasure permission of the driving information (S442). In such case, the ECU 10 transmits a vehicle model of the subject vehicle to the remote center 60 together with the VIN.

The ECU 10, in S444, monitors whether an erasure permission is obtained from the remote center 60. When no reply for a request of the erasure permission is obtained from the remote center 60 (S444: No), the ECU 10 concludes the present process.

When a reply for a request of the erasure permission is obtained from the remote center 60 (S444: Yes), the ECU 10, in S446, erases the driving information stored in EEPROM 38, and concludes the present process.

(Fourth Driving Information Handling Process)

With reference to FIG. 5, the remote center 60, in S450, determines whether a vehicle has referred to the remote center 60 for erasure permission, which may be sent by the vehicle in S442 of FIG. 4. When the vehicle refers to the remote center 60 regarding the erasure permission of the driving information (S450: Yes), the process, in S452, determines whether to permit the erasure of the driving information of the vehicle based on the vehicle model and the VIN that have been transmitted from the vehicle.

The remote center 60 maintains a database having the vehicle model and the VIN of the vehicle with erasure permission or erasure prohibition associated with the vehicle. Therefore, based on the vehicle model and the VIN transmitted from the vehicle, the remote center 60 provides a reply indicating either the erasure permission (S454) or the erasure prohibition of the driving information (S456).

When the remote center 60 does not permit the erasure of the driving information, the driving information will be stored in both the vehicle and the remote center 60. In such manner, even if the driving information is erased by mistake on one of the vehicle and the remote center 60, the information on the other side is kept intact.

As a result, when the abnormal time driving information of a certain vehicle model is in high demand, the cause of vehicle abnormality may be analyzed based on the driving information stored in at least one of the vehicle and the remote center 60. For instance, after the release of a certain vehicle model or at a time of receiving many claims from users due to the unexpected vehicle behavior of a certain vehicle model, the cause of vehicle abnormality may be analyzed based on the driving information stored in at least one of the vehicle and the remote center 60.

In the third embodiment, in the third driving information handling process of FIG. 4, a process in S440 may corresponds to a reception unit; and a process in S442 and S444 may correspond to a communication unit; and a process in S446 may correspond to an erase unit.

### Other Embodiments

In the above-described embodiments, the process stores the driving information in EEPROM 38 to analyze the cause of the vehicle abnormality.

Alternatively, the process may store the information in SRAM 36 because a memory such as SRAM 36 meets a requirement that the memory retains the data stored therein even when the vehicle has stopped driving, for the purpose of performing the abnormality cause analysis.

In the second embodiment, the process uses the display 42 of the navigation apparatus 40 as a notification unit to provide information of completion of the erasure process of the driving information. Besides displaying a message via the display 42, the completion information of the erasure process provided by the notification unit may also be provided as, for example, lighting of a lamp or a sound from a speaker.

In the third embodiment, after transmitting the abnormality time driving information from the vehicle to the remote center 60 where such information is stored, the ECU 10 requests the erasure permission for erasing the driving information stored in EEPROM 38 from the remote center 60.

In contrast, the ECU 10 may request the erasure permission from the remote center 60 without transmitting the abnormal time driving information to the remote center 60. In such a case, if the erasure of the driving information is not permitted by the remote center 60, the driving information will not be erased from EEPROM 38. In such manner, during a certain period after a release of a certain vehicle model, or at a time of receiving many claims from users due to the unexpected vehicle behavior of a certain vehicle model, that is, when the abnormal time driving information of a certain vehicle model is in high demand, an accidental erasure of the driving information stored in the vehicle is prevented.

The present disclosure may be applicable to a variety of vehicles. For example, a vehicle having an internal combustion such as a gasoline engine, a vehicle having a diesel engine, a hybrid vehicle using both an internal combustion engine and a motor, and an electric vehicle.

Further, the ECU 10 that realizes, by executing a control program, the function of an abnormality detection unit, a storage control unit, a communication unit, a notification unit, a reception unit and an erase unit in the above embodiment may be at least partially replaced or supplemented by a hardware/hardwired logic that realizes such function by using hardware.

Although the present disclosure has been fully described in connection with the preferred embodiment thereof with reference to the accompanying drawings, it is to be noted that various changes and modifications will become apparent to those skilled in the art, and such changes and modifications are to be understood as being within the scope of the present disclosure as defined by the appended claims.

What is claimed is:

1. An electronic control unit in a vehicle comprising:
an abnormality detection unit detecting a vehicle abnormality;
a storage control unit storing, at a time of detection of the vehicle abnormality by the abnormality detection unit, predetermined driving information of the vehicle in a memory unit, wherein the memory unit retains stored data even when the vehicle has been turned off; and
a communication unit transmitting the driving information stored in the memory unit to a remote center, wherein the remote center stores the driving information, and when the abnormality detection unit detects the vehicle abnormality, the communication unit interrupts a currently performing communication process to transmit the driving information to the remote center after the storage control unit stores the driving information in the memory unit.

2. The electronic control unit of claim 1 further comprising:
a reception unit receiving an erasure request for erasing the driving information stored in the memory unit; and
an erasure unit erasing the driving information stored in the memory unit after reception of the erasure request by the reception unit.

3. The electronic control unit of claim 2, wherein
the communication unit transmits to the remote center an erasure permission inquiry about the erasure of the driving information when the reception unit receives the erasure request for erasing the driving information, and
the erasure unit erases the driving information from the memory unit when the communication unit receives an erasure permission from the remote center.

4. The electronic control unit of claim 2, wherein
the reception unit is blocked from receiving the erasure request when the communication unit is transmitting the driving information to the remote center.

5. The electronic control unit of claim 2 further comprising:
a notification unit notifying, from a notification device, completion of an erasure process for erasing the driving information stored in the memory unit, when the reception unit receives the erasure request for erasing the driving information stored in the memory unit.

6. An electronic control unit in a vehicle comprising:
an abnormality detection unit detecting a vehicle abnormality;
a storage control unit storing, at a time of detection of the vehicle abnormality by the abnormality detection unit, predetermined driving information of the vehicle in a memory unit, wherein the memory unit maintains stored data even when the vehicle has been turned off;
a reception unit receiving an erasure request for erasing the driving information stored in the memory unit;
a communication unit transmitting the driving information stored in the memory unit to a remote center for storing the driving information when the reception unit receives the erasure request for erasing the driving information; and
an erasure unit erasing the driving information stored in the memory unit after (i) the reception unit receives the erasure request and (ii) the communication unit transmits the driving information to the remote center.

7. The electronic control unit of claim 6, wherein
the communication unit transmits to the remote center an erasure permission inquiry about the erasure of the driving information when the reception unit receives the erasure request for erasing the driving information, and
the erasure unit erases the driving information from the memory unit when the communication unit receives an erasure permission from the remote center.

8. The electronic control unit of claim 6, wherein
the reception unit is blocked from receiving the erasure request when the communication unit is transmitting the driving information to the remote center.

9. The electronic control unit of claim 6 further comprising:
a notification unit notifying, from a notification device, completion of an erasure process for erasing the driving information stored in the memory unit, when the reception unit receives the erasure request for erasing the driving information stored in the memory unit.
